(19) United States
(12) Patent Application Publication
(10) Pub. No.: US 2020/0046005 A1
(43) Pub. Date: Feb. 13, 2020

(54) Natural Drink Used in Medical Diagnosis

(71) Applicant: WENDY WAGNER AND LIFETIME PRODUCTS, LLC, Hillsborough, NJ (US)

(72) Inventor: WENDY WAGNER, HILLSBOROUGH, NJ (US)

(21) Appl. No.: 16/059,478

(22) Filed: Aug. 9, 2018

(51) Int. Cl. A23L 33/10; A23L 2/60; C13K 1/00

(52) U.S. Cl. CPC A23L 33/10; A23L 2/60; G01N 37/00; G01N 2800/042; C13K 1/00

(57) ABSTRACT

An oral glucose drink used to diagnose diabetes containing no preservatives, all organic flavoring, and increased tolerability due to natural flavoring. The drink product for diagnosis of a medical condition can include non-GMO dextrose, citric acid, natural flavor and added water.

### BACKGROUND OF THE INVENTION

### 1. Field of the Invention

The present invention relates generally to solutions which are orally ingested and used for medical testing and in particular to an improved glucose formulation containing all natural flavoring with no preservatives.

### 2. Description of the Related Art

During pregnancy, diagnosis of gestational diabetes is important in order to provide treatment leading to decreased maternal and fetal morbidity and mortality. Conventional methodology for diagnosis of gestational diabetes includes a 50 glucose load ingested in five minutes followed in one hour by a blood draw for diagnosis. If the glucose level is above a chosen threshold, a 3 hour 100 gram glucose test is performed including fasting bloodwork followed by bloodwork 1, 2, and 3 hours after a 100 mg glucose load is given to the patient. If 2 of the 4 values are higher than the normal levels, gestational diabetes is diagnosed.

Regardless of the methods or threshold used for the diagnosis of diabetes, patient resistance to the drink itself has been present. There have been complaints about taste, ingredients, and safety of the drink. These issues have led to refusal of use of the drink as well as inability to complete the drink in the prescribed time as well as possible vomiting, leading to inaccurate or incomplete testing.

WO 00/65938 describes a flavored supplementary drink used in diagnosis of diabetes including a dextrose, a sour tasting agent of monohydrate from citric acid, a preservative of sodium benzoate, flavoring agent, food dye and water. The food dye is selected from Red no 40, Blue no 1 and Yellow no. 4. The flavoring agent is selected from citron, lemon/lime, Doonggeulle, coffee, scorched rice tea, green tea and strawberry flavor. The supplementary drinks need to be stored in a dry, dark place and require refrigeration before use. WO 00/65938 is hereby incorporated by reference into this application.

Dyes and certain artificial ingredients are believed to cause serious health problems and are avoided by consumers. During pregnancy, women are especially concerned of consuming food products having dyes and artificial sweeteners which could have effects on their unborn child or children. Consumers have become increasingly wary of artificial ingredients and are looking for natural ingredients, that is, ingredients distilled, extracted, concentrated or similarly obtained from harvested plants and other naturally occurring sources, with limited or no further processing. It is also a concern of consumers to ingest genetically modified organisms (GMO) products and consumers are looking for non-GMO products.

It is desirable to provide an improvement of the drinks used to diagnose diabetes having all natural ingredients which will provide improved test results due to increased patient use, tolerance and satisfaction.

### SUMMARY OF THE INVENTION

The present invention is an improvement on oral glucose drinks used to diagnose diabetes containing no preservatives, all organic flavoring, and increased tolerability due to natural flavoring. In certain exemplary embodiments, the drink product for diagnosis of a medical condition comprises non-GMO dextrose, citric acid, natural flavor and added water. The drink product for diagnosis of a medical condition of the invention provides the consumer with a more palatable, natural sweet flavor than the conventional drink products including dyes, artificial flavors and preservatives. The improved drink product for diagnosis of a medical condition with natural flavors can be used to provide a 50 gram glucose load in pregnancy in order to screen for increased risk of gestational diabetes and decrease the unwillingness to take the test as well as improve the ability for patients to ingest a 10 ounces of the drink product for diagnosis of a medical condition in a required time frame, for example 5 minutes. The present invention can lead to more accurate and precise diagnosis of gestational diabetes. This increase in accuracy of diagnosis can also be found with other types of drinks used to diagnose medical conditions. For example, the present invention provides improved 75 gram glucose load for drinks used for medical diagnosis outside of pregnancy and 100 gram glucose load for drinks used in instances of failed a 50 gram glucose load in drinks for diagnosis of pregnancy. The drink product for diagnosis of a medical condition does not include any artificial ingredients or dyes, including any artificial sweeteners, flavors and preservatives.

In accordance with another aspect, a method for preparing a drink product for diagnosis of a medical condition is provided which comprises mixing together a number of ingredients, all or some of which are optionally pre-combined in any order. The ingredients include Non-GMO dextrose, citric acid, one or more natural flavors and water.

Increase in the incidence of diabetes throughout the world will certainly lead to increased need for accurate diagnosis. The improvement of the drinks used to diagnose diabetes of the present invention will provide improved test results due to increased patient tolerance and satisfaction.

It will be appreciated by those skilled in the art, given the benefit of the following description of certain exemplary embodiments of the beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### DETAILED DESCRIPTION

In certain exemplary embodiments, the drink product for diagnosis of a medical condition comprises non-GMO dextrose, citric acid, natural flavor and added water. The drink product for diagnosis of a medical condition disclosed here can be a ready to drink liquid formulations.

A suitable non-GMO dextrose is a dextrose monohydrate powder of Dextrodyn manufactured by Marroquin Organic International Inc. The amount of non-GMO dextrose in the drink product for diagnosis of a medical condition is in a range of about 10% to about 90%, preferably in an amount of about 15% to about 25%, more preferably in an amount of about 15% to about 20% by weight of the drink product depending on an amount of solvent. Preferably, an amount of about 15.9% of non-GMO dextrose by weight of the drink product is used in the drink product for diagnosis of a medical condition in a 10 ounce serving size

Purified or filtered water can be used in the manufacture of certain embodiments of the drink product. The water typically will be clear, colorless, free from objectionable minerals, tastes and odors, free from organic matter, low in alkalinity and of acceptable microbiological quality based on industry and government standards applicable at the time of producing the beverage. In certain exemplary embodiments, water is added at a level of from about 10% to about 90% by weight of the beverage product, e.g., about 75% to 85% by weigh of the drink product, more preferably 80% to about 85% by weight of the drink product. Preferably, an amount of about 84% of water by weight of the drink product is used in the drink product for diagnosis of a medical condition in a ten ounce serving size.

Various natural flavoring agents include fruit flavors, botanical flavors, spice flavors, and taste modifiers, among others can used in the drink product for diagnosis of a medical condition. Taste modifiers may provide their own characteristic flavor, or may have little or no flavor impact by themselves. Taste modifiers have any one or more of the properties of reducing, masking, or eliminating undesirable taste characteristics, or enhancing desirable taste characteristics, for example, by controlling one or more of sweetness, sourness, bitterness, saltiness, mouthfeel, or taste temporal effects. Non-limiting examples of undesirable taste characteristics reduced by taste modifiers include one or more of bitter aftertaste, metallic aftertaste, astringency, thin mouthfeel, harshness, delayed sweetness onset, lingering sweetness, excess sourness, and other off-notes. Non-limiting examples of desirable taste characteristics enhanced by taste modifiers include one or more of sweetness intensity or impact, fullness or body, and smoothness, among others. Non-limiting examples of taste modifiers include organic acids (e.g., citric acid, malic acid, ascorbic acid, tartaric acid, lactic acid, adipic acid, fumaric acid, gluconic acid, succinic acid, maleic acid, among others), propylene glycol, glycerol, ethanol, and commercially available products

In certain exemplary embodiments, a desired amount of one or more natural fruit flavors is provided to the drink product for diagnosing a medical condition described here. As used herein, the term “natural fruit flavor” refers to any organic fruit fraction, organic fruit component (e.g., rind, zest, pith, pericarp, pulp, flower (e.g., petals), leaf, stem, seed, and the like), from the named fruit flavor (e.g., a combination of fruit essence, fruit oil and/or fruit flavor, such as, e.g., an orange from the named fruit flavor), organic fruit extract (e.g., expressed, absorbed, macerated, distilled and the like), organic fruit oil (e.g., essential oil, folded essential oil), organic fruit essence, organic fruit puree, organic fruit aroma and the like that can be added to a food product to enhance flavor (e.g., to provide and/or enhance one or more high note flavors). In certain exemplary embodiments, one or more natural fruit flavors are used. For example, the natural fruit flavor can be a natural cranberry pomegranate flavor. In certain exemplary embodiments, the fruit flavor is present in an amount of approximately about 0.001% to about 1.0% by weight of the drink product for diagnosis of a medical condition, in an amount of approximately about 0.010% to about 0.75% by weight of the drink product, or in an amount of approximately about 0.10% to about 0.5% by weight of the drink product. In a preferred embodiment an amount of a natural fruit flavor is present in an amount of 0.20% by weight in a ten ounce serving size.

As used here, the term “natural botanical flavor” refers to flavors derived from parts of a plant other than the fruit. As such, natural botanical flavors can include those flavors derived from essential oils and extracts of nuts, bark, roots and leaves. Examples of such flavors include cola flavors, tea flavors, spice flavors and the like, and mixtures thereof. Non-limiting examples of spice flavors include cassia, clove, cinnamon, pepper, ginger, vanilla, cardamom, coriander, root beer, sassafras, ginseng, and others. Numerous additional and alternative natural flavoring agents suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors compliment that of a juice or juice combination.

The natural botanical flavor is present in an amount of approximately about 0.001% to about 1.0% by weight of the drink product for diagnosis of a medical condition, in an amount of approximately about 0.010% to about 0.75% by weight of the drink product, or in an amount of approximately about 0.10% to about 0.5% by weight of the drink product. In a preferred embodiment an amount of a natural botanical flavor combined with a natural fruit flavor is present in an amount of 0.18% by weight in a ten ounce serving size of the drink product.

The natural botanical flavor can be combined with the natural fruit flavor. In one embodiment, a combination of lemon and ginger can be used in the drink product for diagnosis of a medical condition.

Organic acids used in certain exemplary embodiments of the drink products for medical diagnosis disclosed here can serve one or more additional functions, including, for example, lending tartness to the taste of the drink product, enhancing palatability, increasing thirst quenching effect, and acting as a mild preservative. Exemplary organic acids include citric acid, malic acid, ascorbic acid, tartaric acid, lactic acid, adipic acid, fumaric acid, gluconic acid, succinic acid, and maleic acid. Other suitable acids are known and will be apparent to those skilled in the art given the benefit of this disclosure. The particular acid or acids chosen and the amount used will depend, in part, on the other ingredients, the desired shelf life of the beverage product, as well as effects on the beverage pH, titratable acidity, and taste. For example, certain embodiments of the beverage product may include one or more organic acids in an amount from about 0.001% to about 1.0% by weight of the drink product for diagnosis of a medical condition, e.g., about 0.010% to about 0.5% by weight of the drink product. Preferably an amount of 0.20% by weight is used in a drink product for diagnosis of a medical condition in a ten ounce serving size.

In one embodiment a 10 ounce serving of the drink product for diagnosis of a medical condition is used including a 50 gram load of non-GMO dextrose. In alternate embodiments, a 10 ounce serving of the drink product for diagnosis of a medical condition is used including a 75 gram load of non-GMO dextrose or a 100 gram load of non-GMO dextrose. It will be appreciated that the volumes for the 50 gram, 75 gram and 100 gram drinks of non-GMO dextrose may need to be adjusted to maintain tolerability.

In the following, the invention will be described in detail by way of Examples. The invention, however, should not be limited in any way.

### Example 1

Ingredient

| | | |
|---|---|---|
| Non-GMO Organic dextrose | 49.99 g | 15.9% by weight |
| Citric Acid | 0.30 g | 0.09% by weight |
| Natural Cranberry | 0.59 mL | 0.20% by weight |
| Pomegranate flavor | | |
| Water | 263.48 mL | 83.81% by weight |

Samples of a natural drink product for diagnosis of a medical condition naturally according to this disclosure were prepared by thoroughly mixing the above ingredients.

### Example 2

Ingredient

| | | |
|---|---|---|
| Non-GMO Organic dextrose | 49.99 g | 15.91% by weight |
| Citric Acid | 0.30 g | 0.09% by weight |
| Natural Lemon Ginger Flavor | 0.59 mL | 0.18% by weight |
| Water | 263.48 mL | 83.82% by weight |

Samples of a natural drink product for diagnosis of a medical condition naturally according to this disclosure were prepared by thoroughly mixing the above ingredients.

It is to be understood that the above described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A drink product for diagnosis of a medical condition comprising: non-GMO dextrose, organic acid, natural flavor and water.

2. The drink product of claim 1 wherein the organic acid is selected from citric acid, ascorbic acid, and lactic acid.

3. The drink product of claim 1 wherein the organic acid is citric acid present in an amount of about 0.0010% to about 1.0% by weight of the drink product.

4. The drink product of claim 1 wherein the organic acid is citric acid present in an amount of about 0.20% to about 0.005% in a ten ounce serving size of the drink product.

5. The drink product of claim 1 wherein the non-GMO dextrose is a dextrose monohydrate powder present in an amount in a range of about 10% to about 90% by weight of the drink product.

6. The drink product of claim of claim 1 wherein the non-GMO dextrose is a dextrose monohydrate powder present in an amount 15.9% by weight of the drink product in a ten ounce serving size of the drink product.

7. The drink product of claim 1 wherein the natural flavor is selected from one or more of a natural fruit flavor and a natural botanical flavor.

8. The drink product of claim 7 wherein the natural fruit flavor is a combination of cranberry and pomegranate.

9. The drink product of claim 7 wherein the natural fruit flavor is lemon and the natural botanical flavor is ginger.

10. The drink product of claim 1 wherein the natural flavor is present in an amount of about 0.001% to about 1.0% by weight of the drink product.

11. The drink product of claim 1 wherein the natural flavor is present in an amount of about 0.18% to about 0.20% in a ten ounce serving size of the drink product.

12. The drink product of claim 1 wherein water is present in an amount of about 10% to 90% by weight of the drink product.

13. The drink product of claim 1 wherein water is present in an amount of about 80% to about 85% in a ten ounce serving of the drink product.

14. The drink product of claim 1 wherein the non-GMO dextrose is a dextrose monohydrate powder present in an amount of about 50 grams in a ten ounce serving size.

15. The drink product of claim 1 wherein the non-GMO dextrose is a dextrose monohydrate powder present in an amount of about 75 grams in a ten ounce serving size.

16. The drink product of claim 1 wherein the non-GMO dextrose is a dextrose monohydrate powder present in an amount of about 100 grams in a ten ounce serving size.

17. The drink product of claim 1 wherein the medical condition is diabetes.
